(19) United States
(12) Patent Application Publication
(10) Pub. No.: US 2018/0109474 A1
(43) Pub. Date: Apr. 19, 2018

(54) System and method for integrated private and public instant messaging

(71) Applicant: Iose' Magno, Lamezia Terme (IT)

(72) Inventor: Iose' Magno, Lamezia Terme (IT)

(21) Appl. No.: 15/297,171

(22) Filed: Oct. 19, 2016

(51) Int. Cl. H04L 12/58

(52) U.S. Cl. CPC H04L 51/04; H04L 51/32

(57) ABSTRACT

A computer-implemented method and system for providing users with an integrated private and public instant messaging solution. More particularly, users are enabled both to send/receive private messages to/from other users and to publish public messages not intended to be delivered to any particular recipient but to be made visibile to the entire network of users. Private and public messaging are seamlessly integrated so that when a user replies to a public message from another user, the reply is delivered as a private chat message between the two involved users. Thank to that, users can experience the visibility of a social network and the secrecy of a chat application at once, so that they can share their life and opinions publicly without worrying about being attacked, harassed, trolled or boycotted as it often happens with conventional social networks.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF INVENTION

The present invention relates to instant messaging and, more particularly, to a computer-implemented method and system for providing users with an integrated private and public instant messaging solution.

### BACKGROUND OF THE INVENTION

The current state of art in online communication is highly advanced in its ability to provide users with services that allow them to instant communicate with others. In this area, instant messaging and chat applications, herein referred to as “messaging applications”, are one of the most used tools. They have been available on the market for a long time now and eventually established themselves as mass market mobile applications providing a more cheap, convenient and enhanced form of texting used for as a replacement for the carriers' native service (SMS/MMS). Indeed, thanks to conventional messaging applications such as WhatsApp and the likes, a user is enabled to send/receive text messages and media files to/from other users belonging to his/her list of contacts mainly, but not exclusively, filled of phone contacts who are using the same application.

Thanks to their easy of use, availability for different mobile operating systems and cost effectiveness, these applications got to become very successful and pervasive, with people using them for one-to-one or group based private texting while turning to social networks for sharing their life and opinions publicly or with their circle of friends. However, social networks cannot ensure the same level of privacy as instant messaging applications because, in contrast to what happens with instant messaging applications where users interact with each others through private chat messages, they enable users to interact with each others mostly through public comments, likes and mentions which are visible to friends or everyone depending on the user's privacy settings. For that reason, people have been exposed to be publicly attacked, harassed and trolled to the extent that many of them now feel overexposed and not very, or not at all, secure using social networks.

Hence, in the ongoing quest for a better online communication solution, it would be highly desirable to provide an enhanced messaging application which allows its users also to share their life and opinions publicly without being subject to the aforementioned compromising limitations.

### SUMMARY OF THE INVENTION

The present invention discloses a computer-implemented method and system for providing users with an integrated private and public instant messaging solution. More particularly, users are enabled both to send/receive private messages to/from other users and to publish public messages not intended to be delivered to any particular recipient but to be made visibile to the entire network of users.

Private and public messaging are enjoyed in a seamlessly integrated experience by which when a user replies to a public message from another user, the reply is delivered as a private chat message between the two involved users. Thanks to that, people cannot be publicly attacked, harassed or boycotted as it may happen on social networks. This dramatically improves people's freedom of expression and engagement as well as the quality of the users conversations. For example, the user willing to share something publicly will no more experience a few common concerns such as: “Are people going to engage with what I'm going to publish?”, “Will I be attacked due to what I'm going to say?” and the likes. Furthermore, the user who intends to reply to a public message from another user will feel free to be himself/herself because no one, except the targeted user, will read his/her reply. For the same reason, people will also be discouraged from writing mean messages and naturally encouraged to maintain an overall polite well-mannered behavior. In addition, public messages create the opportunity for people to have private conversations even without having to especially go initiate them and, therefore, without worrying about disturbing the others with their messaging activity.

Thanks to the experience provided by the present invention, people will feel much more in control of their network so that they will add to their contacts even persons out of their inner circle of friends without feeling overexposed, which would be the case if, for example, they were doing the same thing on a conventional social network such as Facebook. Also, the contacts of each user are not visible to the others so that the experience cannot degenerate into a popularity contest about who has more friends and what type of friends do they have, which is also typical of conventional social networks.

In its broadest aspect and scope, this invention provides people with a more convenient tool to setup a presence online for sharing their life and opinions publicly while, at the same time, enjoying private chats on what they share.

The foregoing features of the present invention, along with the advantages achieved thereby, will be apparent to one of ordinary skill in the art from the following more detailed description of a preferred embodiment as illustrated in the accompanying drawings.

### BRIEF DESCRIPTION OF THE DRAWING

The features and advantages of the present invention will be more clearly understood and appreciated from the following detailed description taken in conjunction with the accompanying drawings, in which:

FIG. 1 illustrates an example integrated private and public instant messaging system according to one embodiment of the present invention;

FIGS. 2, 3, 4 and 5 illustrate, according to one embodiment of the present invention, a method and steps for having private chats with other users by sending to them private messages in reply to or with reference to their public messages.

### DETAILED DESCRIPTION OF THE INVENTION

Hereinafter, a preferred embodiment of the present invention is disclosed in more detail with reference to the accompanying drawings to facilitate an understanding of the features and principles of the invention. While embodiments of the present invention will be described, for purposes of illustration, in the context of a mobile screen user interface, it will be understood that they may be implemented, with appropriate variations and modifications, on a computer screen user interface, a tablet screen user interface or any other networked environment user interface without departing from the principles of the invention.

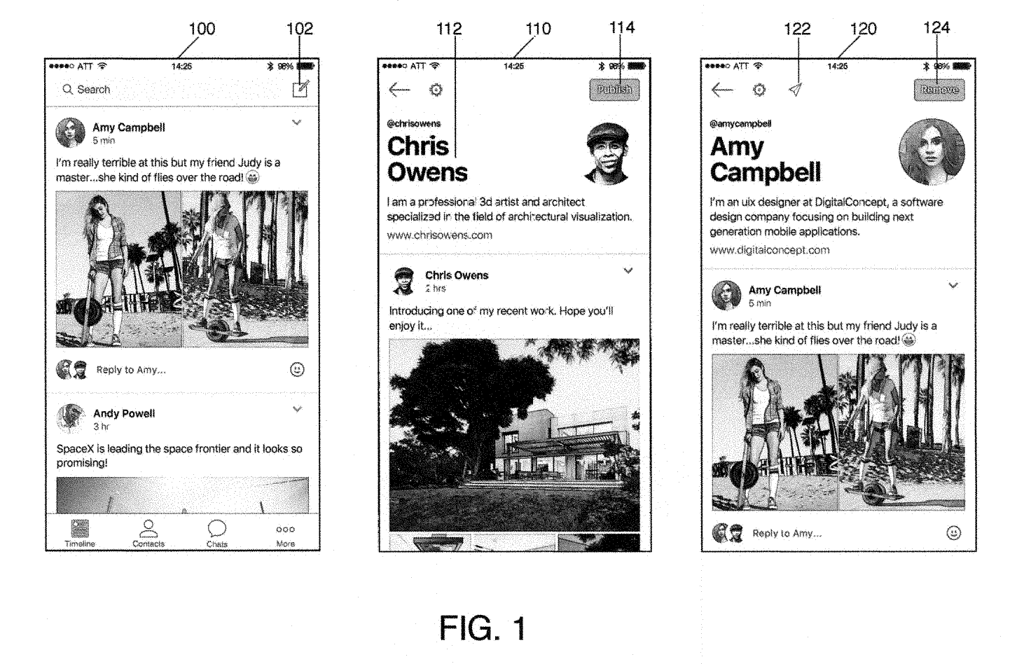

A conventional messaging application offers its users the ability to communicate with each others by sending and receiving private messages in one on one or group based chat sessions. Users can access their ongoing chats easily from a Chats screen each time they need to send a message or read an incoming one. Referring now to FIG. 1, there is shown an example of a messaging application according to an embodiment of the present invention by which the users can send and receive private messages as well as publish public messages which are not intended to be delivered to any particular user but to be made visibile to the entire network of users. Private and public messaging are seamlessly integrated so that when a user replies to a public message from another user, the reply is delivered as a private chat message between the two involved users.

As shown in FIG. 1, an application user (in this case, “Chris Owens”) is provided with a public profile 110 to share personal information 112 and publish public messages 114. These latter are displayed chronologically right below the user's personal information. Visiting the profile of another user 120, the application user is enabled to add/remove that user to/from his contacts 124, view the public messages written by that user and, if authorized, send that user a message 122. In contrast to the experience provided by conventional social networks such as Facebook and the likes, everything the users share on their profile cannot be publicly commented on or liked. Thanks to that, users are prevented from being publicly attacked, harassed, trolled or boycotted and, at the same time, any popularity contest by which they may be judged by how many comments or likes they receive is avoided. Also, users are allowed to add contacts instead of friends and their contacts list is not visible to the others. Thanks to that, any popularity contest by which people may be judged by how many and what type of friends do they have is avoided. The aforementioned overall experience dramatically improves freedom of expression and the quality of time spent using the application.

Referring again to FIG. 1, a Timeline screen 100 provides the application user with a constantly updated list of public messages from his contacts as well as enables him to publish a public message by tapping the Write icon 102.

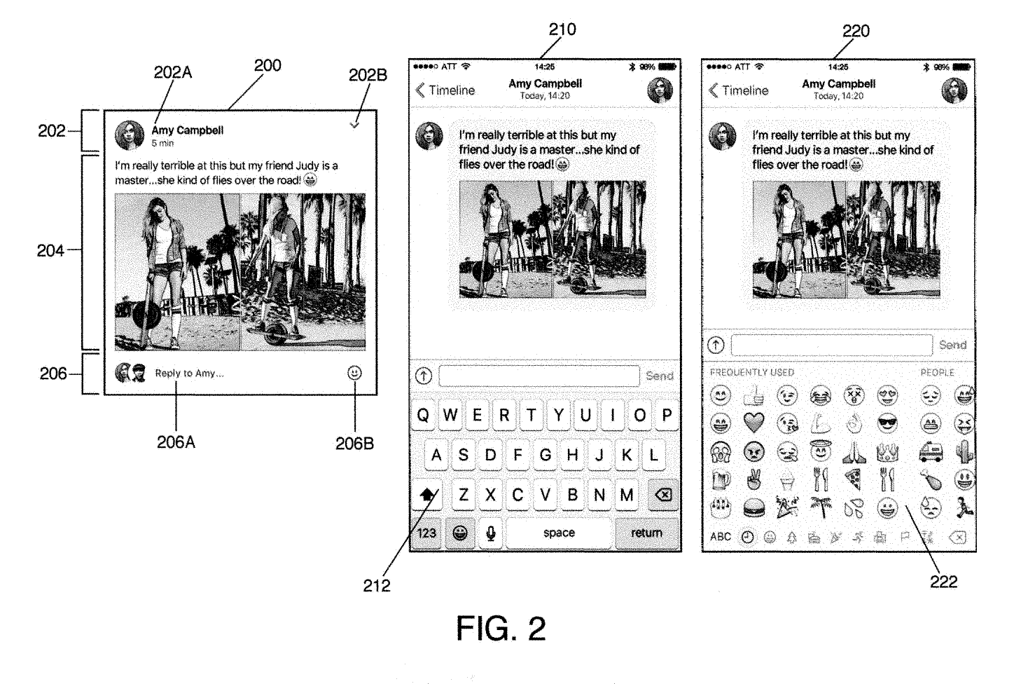

FIG. 2 illustrates an example public message 200 from a particular user (in this case, “Amy Campbell”). The message is comprised of a header 202, a body 204 and a footer 206. The header 202 is comprised of two parts, one that displays the name and the thumbnail of the message's owner along with the time elapsed since the publication of the message 202A and another that displays an icon for accessing a menu of commands for the message 202B. The body 204 may contain text, emoticons, links, images, videos, etc. The footer 206 enables the application user to send a private message to the message's owner in reply to or with reference to his/her message. The footer item will be visible only if the application user is allowed to send a private message to the message's owner and it is comprised of two parts, one that displays the thumbnails of the message's owner and the application user side by side, plus a label reading “Reply to” followed by the name of the message's owner 206A (in this case, “Reply to Amy . . . ”), and another that displays an emoticon icon 206B. Tapping the “Reply to” item 206A will open up a Reply screen 210 preset with the standard keyboard 212 while tapping the emoticon icon 206B will open up a Reply screen 220 preset with the emoticon keyboard 222. This latter case may result useful when the intended message of the application user starts with or is entirely composed of emoticons. It's worth pointing out that the example public message 200 represents the presently preferred way of displaying a public message but there can be many variations or modification of it. However, all the possible variations and modifications do not depart from the scope as disclosed herein, which is to publicly display a message from an user and to allow other users to send a private message in reply to or with reference to it.

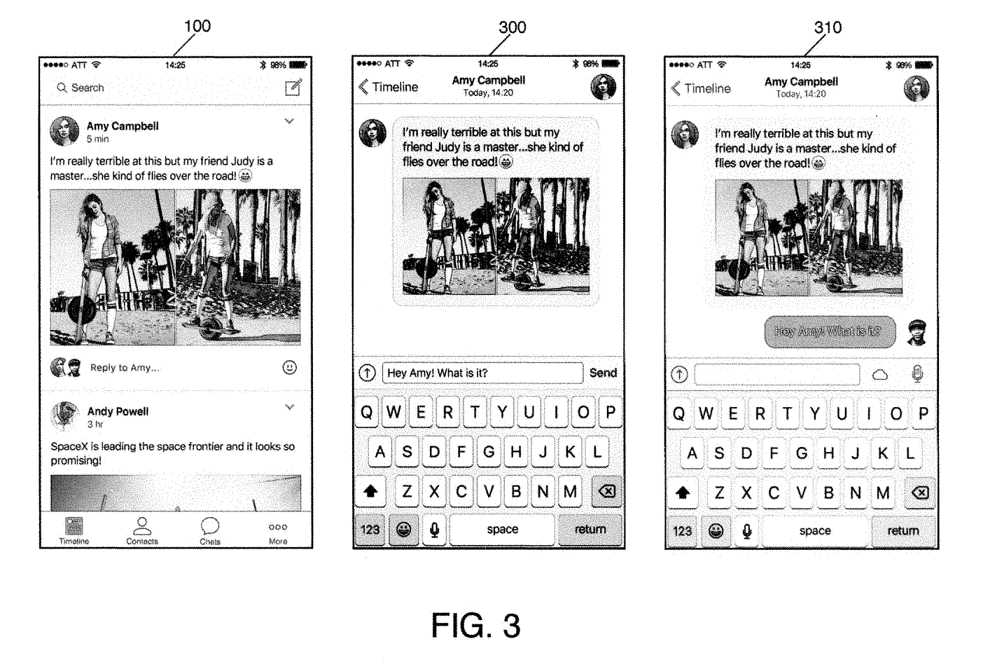

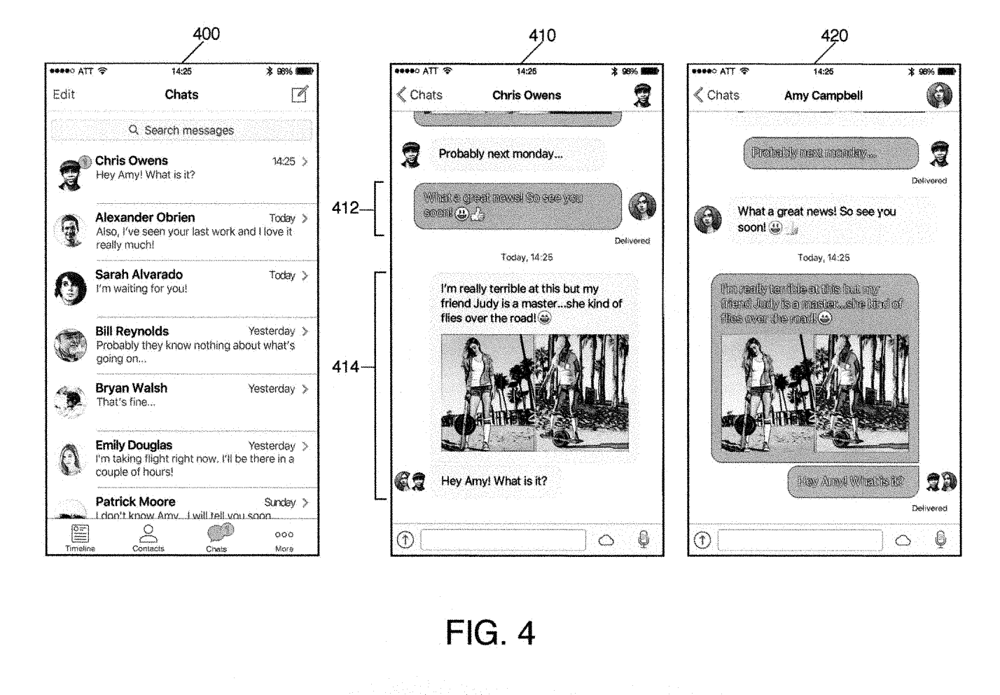

To explain how private and public messaging are seamlessly integrated, an example scenario is provided in which, as illustrated in FIG. 3, the application user (Chris Owens) sends a message in reply to or with reference to a public message of another user (Amy Campbell). In particular, Chris discovers the public message of Amy while visiting his Timeline screen 100 and replies to it as shown by screens 300 and 310. The reply is then delivered to the recipient as a chat message, therefore, as illustrated in FIG. 4, it is instantly notified inside the Chats screen of the recipient 400 and displayed inside the Chat screen shared by the recipient and the sender as shown by screens 410 and 420 (which respectively illustrate the Chat screen as it is viewed by Amy and by Chris).

As it can be noticed, a chat message displayed in a Chat screen differs depending on whether it refers to a private message written by the user inside the Chat screen or to a private message written by the user in reply to or with reference to a public message. In the first case, as it is represented by the example message 412, the chat message is comprised of the thumbnail of the sender of the private message and a balloon containing the private message itself. In the second case, as it is represented by the example message 414, the chat message is comprised of the thumbnails of the sender of the private message and the owner of the public message to which it refers to, a balloon containing the private message and a balloon containing the public message itself. In that way, the recipient of the message is made aware that the incoming chat message refers to one of his/her public messages, so that he/she is enabled to understand it properly.

It's worth pointing out that the example chat message 414 represents the presently preferred way of displaying a private message written in reply to or with reference to a public message but there can be many variations or modification of it. For example, the same result can be achieved using a different shape for balloons, without using the balloons, without displaying the users thumbnails, placing the elements with a different layout, and the likes. However, all the possible variations and modifications do not depart from the scope as disclosed herein, which is to display a private message sent from one user in reply to or with reference to a public message of another user, along with the public message to which it refers to, inside the Chat screen shared by the two users.

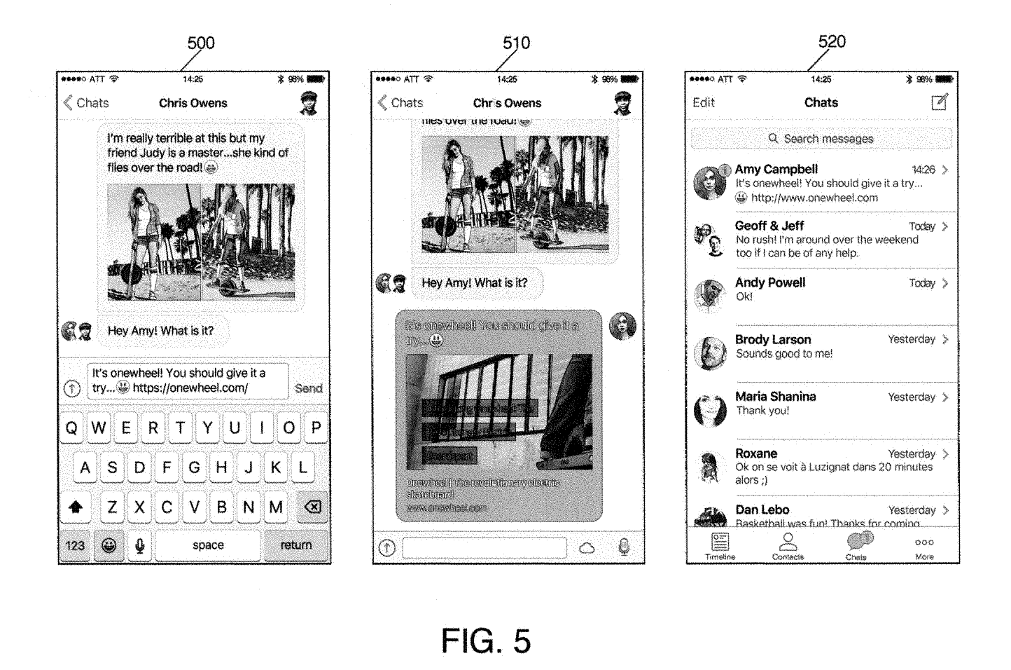

Also, as illustrated in FIG. 5, it's worth noticing that the user who receives a private message in reply to or with reference to one of his/her public messages can in turn reply that message inside the Chat screen he/she shares with the sender of the message. In particular, screens 500 and 510 show how Amy replied to Chris who is then instantly notified as shown by screen 520. Obviously, the two users can keep chatting each other as long as they need it.

The above disclosed method, which enables users to have private chats on their public messages, not only alleviates pressure on the users themselves but also does create a more authentic interactions all around. In fact, the user who intends to publish a public message will feel safe, protected and in control of the situation because any reply to his/her message from other users will not be publicly visible, while the user who intends to reply to a public message from another user will feel free to be himself/herself because no one, except the targeted user, will read his/her reply. For the same reason, that user will also be discouraged from writing mean messages and naturally encouraged to maintain an overall polite well-mannered behavior.

In broad embodiment, the present invention is an integrated private and public instant messaging application providing people the visibility of a social network and the secrecy of a chat application at once, so that they can share their life and opinions publicly without exposing themselves to be attacked, harassed, trolled or boycotted from the others.

While the foregoing written description of the invention enables one of ordinary skill to make and use what is considered presently to be the best mode thereof, those of ordinary skill will understand and appreciate the existence of variations, combinations, and equivalents of the specific embodiment, method and examples herein. Accordingly, the disclosure of the present invention is intended to be illustrative, but not limiting, of the scope and spirit of the invention.

What is claimed is:

1. A messaging application comprising:
means for sending/receiving private messages to/from others users;
means for publishing public messages not intended to be delivered to any particular user but to be made visibile to the entire network of users; and
means for having private chats with other users by sending to them private messages in reply to or with reference to their public messages;
whereby users can enjoy the visibility of a social network with the secrecy of a chat application at once, so that they can share their life and opinions publicly without worrying about being attacked, harassed, trolled or boycotted.

2. The messaging application of claim 1, wherein a public message comprises means for providing users with a Reply screen, preset with a standard keyboard or with an emoticon keyboard, for typing and sending a private message.

3. The messaging application of claim 2, wherein said private message is delivered to the owner of said public message and displayed, along with said public message to which it refers to, inside the Chat screen shared by the sender of said private message and the owner of said public message.

4. A method for communicating by using a messaging application comprising:
sending/receiving private messages to/from others users;
publishing public messages not intended to be delivered to any particular user but to be made visibile to the entire network of users; and
means for having private chats with other users by sending to them private messages in reply to or with reference to their public messages;
whereby users can enjoy the visibility of a social network with the secrecy of a chat application at once, so that they can share their life and opinions publicly without worrying about being attacked, harassed, trolled or boycotted.

5. The method of claim 6, wherein a public message comprises means for providing users with a Reply screen, preset with a standard keyboard or with an emoticon keyboard, for typing and sending a private message.

6. The method of claim 7, wherein said private message is delivered to the owner of said public message and displayed, along with said public message to which it refers to, inside the Chat screen shared by the sender of said private message and the owner of said public message.
